(19) United States
(12) Patent Application Publication
(10) Pub. No.: US 2025/0226471 A1
(43) Pub. Date: Jul. 10, 2025

(54) Method for Generating a Recyclate from Dry Coating Material, Recyclate, Method for Solvent-Free Electrode Production and Electrode

(71) Applicant: Bayerische Motoren Werke Aktiengesellschaft, Muenchen (DE)

(72) Inventors: Korbinian HUBER, Muenchen (DE); Michael WAGNER, Simbach (DE)

(21) Appl. No.: 18/852,570

(22) PCT Filed: May 4, 2023
(86) PCT No.: PCT/EP2023/061777

§ 371 Date: Sep. 30, 2024

(30) Foreign Application Priority Data
May 30, 2022 (DE) 10 2022 113 504.7

(51) Int. Cl. H01M 10/54; C22B 1/24; H01M 4/04; H01M 4/62

(52) U.S. Cl. CPC H01M 10/54; C22B 1/24; H01M 4/0411; H01M 4/623; H01M 4/625

(57) ABSTRACT

A method for generating a recyclate from dry coating material includes providing an agglomerated solidified coating material, where the coating material has a binder in the form of fibrils which form aggregates. A recyclate is generated by introducing forces, especially shearing forces, into the coating material in such a way that the agglomerate is broken up and the aggregate-forming fibrils are retained.

### BACKGROUND AND SUMMARY

The present invention relates to a method of generating a recyclate from dry coating material, to a recyclate, to a method of solvent-free electrode production and to an electrode.

Partly or fully electrically driven motor vehicles will dominate the streetscape in the foreseeable future. For reasons of sustainability, but also to save costs, it is necessary to find ways and means of recycling the energy storage cells used, which are currently often lithium ion cells. Residues or rejects obtained in the production process should also be reused or used further. DE 699 05 134 T2 relates to the recovery of material from coated substrates consisting of a substrate sheet with a coating applied thereto and containing that material. The coating comprising particles or powders is ground. However, it has been found that simple grinding is not optimal in the case of dry-coated electrodes since the coating material here is subjected to impermissibly high stress.

It is therefore an object of the present disclosure to specify a method of generating a recyclate from dry coating material, a recyclate, a method of solvent-free electrode production and an electrode, which eliminate the aforementioned disadvantages and in particular enable reuse or further use of dry coating material from battery electrodes.

This object may be achieved by a method of generating a recyclate, a recyclate, a method of solvent-free electrode production, and an electrode according to the claims. Further advantages and features will be apparent from the dependent claims and from the description and the appended figures.

According to this disclosure, a method of generating a recyclate from dry coating material may comprise the steps of: providing agglomerated, solidified coating material, especially dry coating material, where the coating material includes, as binder, fibrils that form aggregates; and generating a recyclate by introducing forces, especially shear forces, into the coating material in such a way that agglomerates are parted or broken up, and the fibrils that form the aggregates are conserved or at least conserved as far as possible, or essentially conserved.

The expression “recyclate” in the present context means a material or substance that has already been processed at least once. In other words, the material or substance comes from a recycling process. Alternatively, it can also be referred to as a secondary raw material. In the present context, it has been found that dry coating material from battery electrodes is advantageously processed in such a way that the fibril structure is conserved. The fibrils serve as binder in the dry coating material. A particularly advantageous processing method has been found to be one in which the agglomerate structure is broken up without damaging the advantageous fibril structure. For this purpose, the introduction of force is appropriately conducted in such a way that deagglomeration is brought about without bringing about deaggregation. Unspecific comminution of the coating material would lead to reduced recyclate quality.

In one embodiment, the characteristics or quality of the recyclate are detected, especially by measurement. It is thus possible to find out whether the fibril structure in the recyclate is maintained or the force is introduced in such a way that the aggregate structure is conserved. A suitable method of detecting characteristics/quality has been found to be the use of electron microscopy. Also suitable are x-ray diffractometry (XRD), also called x-ray diffraction, or vibrational spectroscopy (IR, Raman). The aforementioned examples should not be considered to be exhaustive.

It has been found that particularly gentle introduction of force is achieved by the introduction of shear forces. The method appropriately may comprise the step of introducing the forces, especially the shear forces, via pressure comminution, percussive comminution, friction comminution, cutting comminution and/or impact comminution.

There are appropriately suitable apparatuses or machines for each of the aforementioned mechanisms of action that can be used appropriately in the present context.

In one embodiment, the forces are introduced using one or more of the following apparatuses: grinding ball mill, standard ball mill, mortar mill, crusher, hammer mill.

A particularly advantageous method has been found to be comminution by means of an impact mill. In fact, however, the most suitable tool should be ascertained depending on the individual case. The same applies to the method parameters/machine parameters used in the use of the apparatuses. As already mentioned, the characteristics of the recyclate are preferably monitored by measurement, such that any process parameters can be adjusted accordingly. One particular aim is to obtain the advantageous fibril structure.

In one embodiment, the method may comprise the step of providing the coating material as a free-standing electrode film.

This may be reject material obtained in production. In such an electrode film, the coating material may be in an agglomerated and solidified form. The terms “agglomerated” and “solidified” serve in particular to distinguish from a powdery or particulate state of the coating material.

The coating material is in agglomerated or solidified form even when it has been applied to the or a carrier material, also called a carrier film. In one embodiment, the method comprises the steps of: providing an electrode comprising a carrier material coated with the coating material; and parting or separating the coating material from the carrier material.

The parted and separated coating material which is still in agglomerated or solidified form is deagglomerated thereafter, appropriately via the introduction of forces, advantageously conserving the fibrils that form the aggregates. This embodiment is especially a variant of the method suitable for reprocessing of already used electrodes.

The technology further relates to a recyclate produced by the method of the disclosure. Such a recyclate is, for example, in powdery or particulate form. The aforementioned powders or particles are formed by the aggregates, which are in turn held together via the fibril structure.

The technology also relates to a method of solvent-free electrode production, wherein the recyclate of the disclosure is used for production.

In one embodiment, the method of solvent-free electrode production comprises the steps of: processing the recyclate of the invention in a (multishift) extruder, to create a coating material; and applying the coating material to a carrier material.

Alternatively or additionally, the method comprises the steps of: creating coating material, especially in a multishaft extruder; and adding the recyclate to the coating material.

Advantageously, when a multishaft extruder is used, it is possible to implement a continuous mixing process which, compared to batchwise mixing processes or semicontinuous processes as implementable in a jet mill, for example, enable an increase in productivity and a reduction in costs and energy demand. When jet mills are used, for example, degradation of the electrochemically active components (especially of intercalated graphites, but also of other materials, such as oxides and silicon materials) can additionally occur, since the stress needed for fibrillation of the binder also brings about grinding of the other components. Particularly advantageously, it has been found that the degree of fibrillation can be controlled via the multishaft extruder. There are a number of parameters available for this purpose, for example process temperature, throughput, speed and configuration of the kneading and/or mixing elements used in the multishaft extruder. After processing in the multishaft extruder, the coating material is in powdery form. Such a powder comprises particles, granules etc. The binder component is in fibrillated form. The grain size of the aforementioned elements is appropriately likewise adjustable via the multishaft extruder.

Since no degradation of the binder fibrils is brought about via the introduction of forces, such as the shear forces in particular, or via the use of suitable techniques (cf. the aforementioned impact mill), further fibrillation of the recyclate in a (multishaft) extruder is not absolutely necessary. The present recyclate thus advantageously need not be processed further, or is advantageously directly suitable for coating of a carrier material or as addition for an (already fibrillated) coating material.

In one embodiment, the coating material may consist entirely (to an extent of 100%) of the recyclate. The recyclate can also be added to the coating material as a constituent. In one embodiment, this can be effected in the creation of the coating material in the (multishaft) extruder. The recyclate is added to the extruder here together with the further materials, such as active material etc., and processed together therewith. Alternatively or additionally, the recyclate can be added subsequently to the coating material generated for example in a (multishaft) extruder, in particular, for example, “folded in” (for example by addition to the collecting vessel/buffer vessel at the extruder, which is mixed in).

The technology further relates to an electrode for an electrical energy storage cell, comprising a carrier material having a coating, where the coating has been produced at least partly from the recyclate of the disclosure.

In a preferred embodiment, the electrode has been produced by the method of the disclosure for solvent-free electrode production.

In one embodiment, the constituents of the coating are an electrochemically active material, a conductivity additive and a fibrillatable material. The constituents have appropriately been provided entirely or at least partly by the recyclate.

The coating material of the electrode may consist entirely of the recyclate. Alternatively, the proportion of recyclate in percent by weight may be only up to 10%, up to 20%, up to 30%, up to 40%, up to 50%, up to 60%, up to 70%, up to 80% or up to 90%.

In one embodiment, the fibrillatable material is PTFE (polytetrafluoroethylene, Teflon). In one embodiment, the coating also comprises multiple fibrillatable materials or mixture constituents, where further fibrillatable constituents are, for example, PVDF (polyvinylidene fluoride) or PE (polyethylene). In one embodiment, it is possible to use recyclates obtained from different coating materials. Different coating materials in particular mean coating materials of different compositions.

In one embodiment, the electrochemically active material is, for example, a cathode material, the conductivity additive is a conductive carbon black, and the fibrillatable material is PTFE. Preferred cathode materials are: LCO (lithium cobalt oxide), LMS or LMO (lithium manganese oxide spinel), NMC or NCM (lithium-nickel-cobalt-manganese), LFP (lithium iron phosphate), NCA (lithium-nickel-cobalt-aluminum oxide) or NCMA (nickel-cobalt-manganese-aluminum).

In a preferred embodiment, the electrochemically active material comprises 92-99% by weight, the conductivity additive 0.5-5% by weight, and the fibrillatable material 0.5-3% by weight.

Further advantages and features will be apparent from the description below of an embodiment of the method, with reference to the appended figures.

### BRIEF DESCRIPTION OF THE DRAWINGS

The figures show:

FIG. 1: a schematic diagram of an embodiment of an electrode, comprising a carrier material including coating;

FIG. 2: a schematic diagram for illustration of the structure of the coating material;

FIG. 3: a schematic view of a multishaft extruder.

### DETAILED DESCRIPTION OF THE DRAWINGS

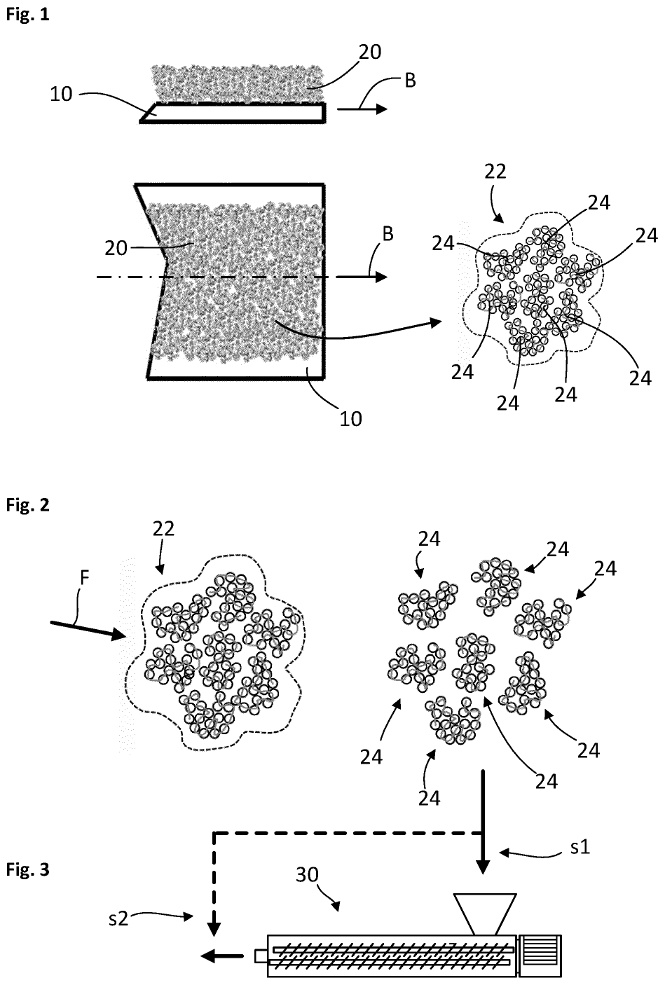

FIG. 1 shows a small detail of an electrode extending in a web direction B, comprising a carrier material or a carrier film 10, on which coating material 20 has been applied, on one side in the present case by way of example. Shown in the upper half of the drawing is a side view, and the drawing below shows a top view. The coating material 20 is in solidified or agglomerated form. In the right-hand half of the drawing, a region of the coating material 20 is shown in enlarged form. A “part-agglomerate” 22 is apparent, comprising a multitude of aggregates 24. The aggregates 24 in turn comprise primary particles (electrochemically active material, conductivity additive). The primary particles are bonded by the fibrils.

FIG. 2 shows the part-agglomerate 22 known from FIG. 1. The arrow with reference sign F is intended to symbolize an introduction of force. In the present context, a processing method is proposed, which is suitable for breaking up agglomerates, but without damaging the advantageous fibril structure. What is desired, in other words, is deagglomeration, not deaggregation. This is shown schematically in the right-hand half of the image. The drawing shows the aggregates 24, which are self-contained, held together by the fibrils. However, the agglomerate structure has been broken up. Such a material or such a recyclate is of excellent suitability for further use or further processing.

FIG. 3 shows a schematic of a multishaft extruder 30. This can be supplied with a recyclate as part-constituent or else main constituent (cf. FIG. 2), in order to generate a coating material therefrom for the dry coating of electrodes. According to option s1, the recyclate, similarly to the other constituents of the coating, is added to the multishaft extruder 30. Since the present recyclate advantageously has an intact or largely intact fibril structure, there is advantageously no need at all for (re) processing in a (multishaft) extruder. Subsequent addition of the recyclate, as indicated by reference numeral s2, is therefore likewise advantageously possible additionally or alternatively.

### LIST OF REFERENCE NUMERALS

10 carrier material
20 coating material
22 part-agglomerate
24 aggregate
30 multishaft extruder
F force
B web direction
s1, s2 options

1-14. (canceled)

15. A method of generating a recyclate from dry coating material, the method comprising:
providing a coating material in an agglomerated and solidified form, the coating material including, as a binder, fibrils that form aggregates;
generating a recyclate by introducing forces into the coating material, whereby agglomerates are broken up and the fibrils that form the aggregates are conserved.

16. The method according to claim 15 comprising:
introducing the forces via pressure comminution, percussive comminution, friction comminution, cutting comminution and/or impact comminution.

17. The method according to claim 15,
wherein the forces comprise shear forces.

18. The method according to claim 15,
wherein the forces are introduced using an apparatus selected from the group consisting of: grinding ball mill, standard ball mill, mortar mill, crusher, and hammer mill.

19. The method according to claim 15,
wherein comminution is effected using an impact mill.

20. The method according to claim 15,
wherein the aggregates comprise primary particles of an electrochemically active material and/or a conductivity additive.

21. The method according to claim 15,
wherein the primary particles are bonded by the fibrils.

22. The method according to claim 15, further comprising:
providing the coating material as a free-standing electrode film.

23. The method according to claim 15, further comprising:
providing an electrode comprising a carrier material coated with the coating material; and
separating the coating material from the carrier material.

24. A recyclate produced by the method according to claim 15.

25. A method of solvent-free electrode production utilizing the recyclate according to claim 24.

26. The method according to claim 25, further comprising:
processing the recyclate in an extruder to create a coating material; and
applying the coating material to a carrier material.

27. The method according to claim 26, wherein the extruder is a multishaft extruder.

28. The method according to claim 25, further comprising:
creating coating material in an extruder; and
adding the recyclate to the coating material.

29. The method according to claim 28, wherein the extruder is a multishaft extruder.

30. An electrode for an electrical energy storage cell, the electrode comprising:
a carrier material having a coating,
wherein the coating has been produced at least partly from a recyclate according to claim 24.

31. An electrode produced by the method according to claim 25.

32. The electrode according to claim 31,
wherein the coating comprises constituents including:
an electrochemically active material;
a conductivity additive; and
a fibrillatable material.

33. The electrode according to claim 32,
wherein the constituents are provided entirely or at least partly by the recyclate.
